(19) United States
(12) Patent Application Publication
(10) Pub. No.: US 2003/0190039 A1
(43) Pub. Date: Oct. 9, 2003

(54) Saturable core POTS/DSL filter

(75) Inventors: Stephen Michael Sedio, Valley Center, CA (US); Richard Lao, San Diego, CA (US)

Correspondence Address: David B. Abel, Esq., Squire, Sanders & Dempsey L.L.P., 14th Floor, 801 S. Figueroa Street, Los Angeles, CA, 90017-5554, US

(73) Assignee: Sumida America Technologies

(21) Appl. No.: 10/117,530

(22) Filed: Apr. 4, 2002

(51) Int. Cl. H04M 1/00; H04M 9/00

(52) U.S. Cl. 379/387.01

(57) ABSTRACT

This invention relates generally to electronic filter circuits on POTS (Plain Old Telephone System) lines and more particularly to an electronic filter circuit which contains a magnetically saturable inductor switch. The switch enables multiple POTS device micro-filter combinations to be simultaneously active without the drawbacks of the prior art.

### BACKGROUND OF THE INVENTION

1. Field of the Invention

This invention relates generally to electronic filter circuits on Plain Old Telephone System (POTS) lines and more particularly to an electronic filter circuit which incorporates a saturable magnetic core. The filter circuit enables multiple POTS devices with their associated filters to be placed on a POTS line without causing undesirable signal attenuation.

2. General Background and State of the Art

The use of a Digital Subscriber Line (DSL) Internet access service has gained widespread popularity as a technology in which advanced modems are used to increase data transmission speeds over regular telephone lines, sometimes referred to as a Plain Old Telephone System (POTS) lines. DSL, as used in this document, is understood to include, but is not limited to, various modes of DSL known as HDSL, ADSL, VDSL. In any establishment using a POTS line, such as for example residential homes and office complexes, communications devices such as telephones, facsimile machines, DSL modems and other devices are typically connected in parallel across the common POTS line. Deployment of DSL modems on a POTS line requires the installation of filters on all of the POTS communication devices on the line. The filter blocks certain frequencies ensuring that voice transmission over the telephone lines is not disturbed during data transmission by a DSL modem. However, each filter connected to a POTS device constitutes an electrical load on the POTS line. This electrical load causes attenuation of the electrical signal, resulting in increased signal reception errors and degraded DSL performance.

Specifically, the filter typically contains an electrical capacitor that bypasses a portion of the electrical signal around the receiving circuitry. This capacitor may cause attenuation of the electrical signal(s) going through the POTS line even when the device to which the filter capacitor is connected is not in use. If multiple telephones, facsimile machines, DSL modems, and/or other POTS communication devices are connected to the same DSL line, each with its own filter, undesirable attenuation of the incoming DSL signal may occur due to the shunting effect of the capacitors in each of the filters. However, if the POTS device connected to the circuit is not in use, there is no need for the filtering function caused by the filter capacitor for these POTS devices.

Existing filters may use active and/or solid state components to switch off the filter's capacitor when the POTS device to which it is attached is not in use. However, these filters are relatively expensive, and may require power even when the POTS device or phone is on-hook which may cause interference with the telephone company switching circuits.

Therefore, there is a need for a passive electronic filter circuit in which the filter capacitor may be activated when the associated POTS device is in use and deactivated when the associated POTS device is not in use.

### SUMMARY OF THE INVENTION

The present invention provides a passive electronic filter circuit that enables a large number of POTS devices to be placed on one POTS line without the filter circuits causing attenuation of a DSL signal. In one exemplary embodiment, the present invention employs a POTS filter circuit which is a low-pass filter having a magnetically saturable core serving as a switch. The magnetically saturable core is wrapped with a coil which is connected to the DC voltage impressed upon the line by the telephone company such that a voltage is always present when the POTS device is off-hook. When the POTS device attached through the filter to the POTS line is not in use (on-hook), there is no direct current power to the coil and thus the core is not magnetically saturated and the filter simulates an open circuit. When a POTS device attached through the filter to the POTS line is in use (off-hook), the DC power provided on the incoming line energizes the coil, magnetically saturating the core and thereby interconnecting a filtering capacitor imposing a DSL signal filter on the POTS line.

Many modifications, variations, and combinations of the methods and systems of filtering are possible in light of the embodiments described herein. The description above and many other features and attendant advantages of the present invention will become apparent from a consideration of the following detailed description when considered in conjunction with the accompanying drawings.

### BRIEF DESCRIPTION OF THE DRAWINGS

A detailed description with regard to the embodiments in accordance with the present invention will be made with reference to the accompanying drawings; wherein:

FIG. 1 shows an exemplary circuit diagram of a filter circuit of the present invention which is adapted to mate with a POTS communication device; and

FIG. 2 shows an alternative circuit diagram of a filter circuit of the present invention.

### DETAILED DESCRIPTION OF THE PREFERRED EMBODIMENTS

The following description should not be taken in a limiting sense but is made for the purpose of illustrating the general principles of the invention. The section titles and overall organization of the present detailed description are for purposes of convenience only and are not intended to limit the present invention.

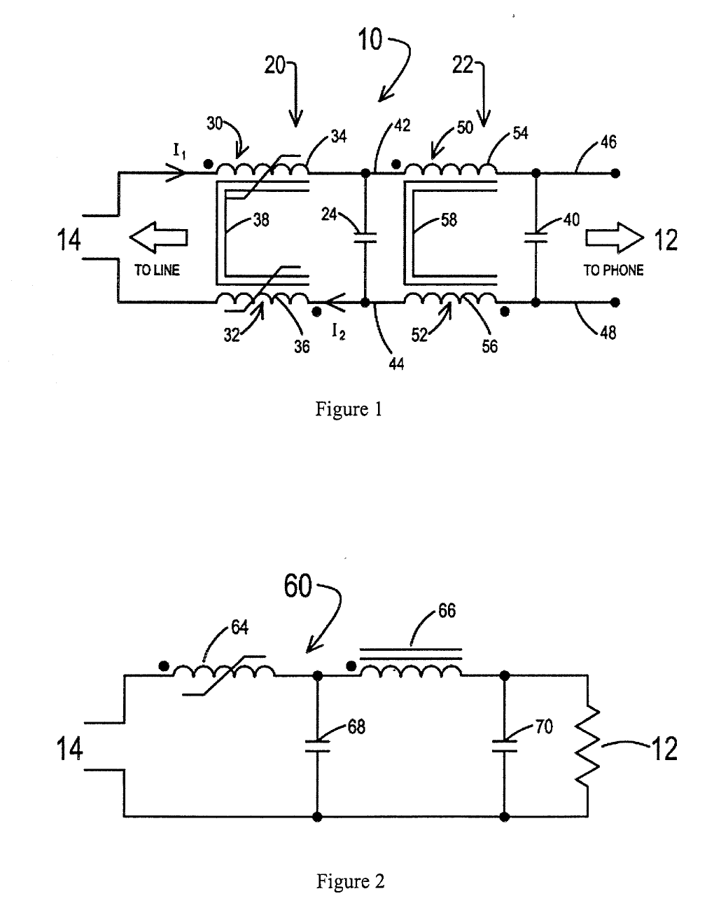

FIG. 1 shows an exemplary circuit diagram of a filter circuit 10 of the present invention which is adapted to mate with a POTS communication device 12 and a POTS line 14. The filter circuit 10 contains a saturable core transformer 20 and a filter transformer 22 both of which are coupled to a filter capacitor 24.

The first component connected to the POTS line 14, i.e. the incoming telephone line, is the saturable core transformer 20. The saturable core transformer 20 includes windings or coils 30 and 32 each having many turns of a conductive element such as a wire 34 and 36, respectively, wrapped around a core 38 of high magnetic permeability saturable ferromagnetic material so as to present a very high inductive reactance (impedance) at all frequencies in both the telephony and DSL bands. Windings or coils 30 and 32 are magnetically coupled to one another and to core 38. Said coupling is such that an electrical current I₁ flowing into coil 30 from POTS line 14 and an electrical current I₂ flowing into coil 32 from conductor 44 generate magnetic fluxes in core 38 that augment or aid one another.

When the telephone or POTS communication device 12 is not in use (on-hook), no direct current (DC) flows through the wires 34 and 36 of the coils 30 and 32, and the filter circuit 10 has a very high impedance, effectively switching OFF or virtually open-circuiting the filter circuit 10 and POTS communication device 12 from the POTS line 14. The inductance and resultant inductive reactance of the coils or windings 30 and 32 are large, so that the very small alternating current (AC) that flows, limited by the large inductive reactance, is insufficient to cause magnetic saturation of the core 38.

When the POTS communication device 12 is in use (off-hook), a direct current (DC) flows through the wires 34 and 36 of the coils or windings 30 and 32, causing magnetic saturation of the core 38. As a consequence, the inductance drops from the on-hook large value to a residual value (not zero) that is, or is approximately, equal to the preferred design value for the inductance required for a low-pass filter having the desired characteristics of cutoff frequency and rate of gain roll-off with frequency. Thus, saturation of the core 38 results in effectively switching ON or virtually closed-circuiting the filter circuit 10 to the telephone line 14. Even a small direct current, on the order of one milli-ampere in the preferred embodiment, is sufficient to magnetically saturate the transformer core 38. When the core 38 saturates, the transformer 20 retains a relatively small residual inductance that is fairly constant over a range of direct currents.

In other words, the saturable core transformer 20 can be effectively electrically connected via saturation or disconnected via unsaturation of the ferromagnetic core 38 by the windings or coils 30 and 32, the saturation and unsaturation occurring as a consequence of a supervisory signal consisting of an electrical direct current of sufficient magnitude through the windings or coils 30, 32.

The geometry of the core 38, as well as the core material, the lamination stacking technique and number of windings or turns of the coil(s) are chosen to provide a residual saturated inductance that is appropriate for the design value that the input inductance should possess for a low-pass filter with the desired gain-frequency characteristics such as cut-off frequency for a DSL signal. As a consequence, at saturation the incoming telephone line is connected to a low-pass filter and its input impedance is whatever input impedance a low-pass filter of that design should possess at any given frequency.

In the embodiment of the invention illustrated in FIG. 1, the filter circuit 10 is a double L-section (LCLC) passive 4^{th} order Chebyshev low-pass filter having saturable core transformer 20 and filter transformer 22 wired as two cascaded coupled transformers, a filter capacitor 24 placed across the conductors 42, 44 connecting the transformers 20 and 22, and a shunt capacitor 40 placed across the output lines 46, 48 of the filter transformer 22. The saturable core transformer 20 includes two coils wound bifilarly, each having 260 turns of #35 AWG SPN enamel coated copper wire (magnet wire) on a custom bobbin, made by cutting off a side of two bobbins (coil formers), P/N BE-16H, DWG. No. P-1626, manufactured by the Pin Hsiang Group (Taiwan). The cut bobbins are then glued together, for example with Loctite 444 Instant Adhesive, so as accommodate twice the core cross-sectional area as one bobbin alone. The bobbin was then wound with one layer of 0.001 inch thick yellow mylar tape to provide additional mechanical support. The resulting DC current resistance, RDC is 21.86 ohms (measured), for the two series connected coils.

The input coupled saturable core transformer 20 has a core 38 constructed out of a stack of EE laminations, Magnetic Metals lamination type 16 ELM, material type HyMu80, performance designation SUPERPERM80. Forty seven laminations, each 0.008 inch thick are fully interleaved with pairs of laminations alternatively inserted from one side of a bobbin and then from the other side of a bobbin, except that the last lamination is inserted alone.

The capacitor 24 in this embodiment may be, for example, a ceramic, X7R formulation 0.1 microfarad, 100V capacitor. The shunt capacitor 40 may be a mylar, 0.056 μfd, 50V capacitor.

In the filter circuit 10 illustrated in FIG. 1, the filter transformer 22 is a cascaded ferrite-core transformer. The filter transformer 22 in this embodiment includes two coils 50, 52 wound bifilarly, each having 229 turns of #33 AWG SPN wire 54, 56 respectively, on a EP17 bobbin or core 58. For example, a Ferroxcube (Philips) type CSH-EP17-1S-8P component may be used for core 58. The direct current resistance, RDC, for both coils 50, 52 measured in series is approximately 9 ohms.

The core 58 of the filter transformer 22 may alternatively be a Ferroxcube (Philips) EP17-3E27 (A_{L}=160 nHy/turnsqd.) with the center-post of one of the core halves ground down to create a sufficient air gap to provide and open circuit inductance (L_{S}) of 33.4 mHy at 1.0 kHz, 100 mVRMS.

The foregoing configuration of the filter circuit 10 provides a passive electrical filter network composed of transformers and capacitors which, upon a change in a switching mechanism in the POTS communication device 12, will cause the electrical input impedance looking into the filter circuit 10 from the POTS line 14 to be changed from its normal off-hook operational input impedance to a very high on-hook input impedance. A very high input impedance in the filter circuit 10 results in very small loading on the POTS line 14 circuit that drives the POTS line 14 and results in the filter circuit 10 appearing as a virtual open-circuit on the POTS line 14. In this way a switched impedance-blocking function is implemented.

The ultimate purpose of switching the passive filter network to a high input-impedance state is to lower the incidence of reception errors on the associated DSL line connected across the filter circuit 10 input terminals and to improve reception on the POTS communication device 12 connected across the filter circuit's output terminals. The POTS line 14 from the telephone company central office has a certain impedance which is usually 600 ohms in the United States. This impedance and the combined parallel input impedances of the filter circuit 10 connected across the incoming POTS line 14 act as a voltage divider that lowers the useable signal level. Smaller signal levels result in more reception errors; larger signal levels result in fewer reception errors.

The present invention exploits magnetic saturation of the core 38 of the saturable core transformer 20 as the switching agent. Additional components are not required, except that in the first embodiment of the invention a larger number of transformer core laminations are required than what would be used for a similar transformer without the impedance switching (impedance-blocking) capability.

Accordingly, one purpose of this invention is to provide a passive inductor-capacitor filter, inductor-resistor filter, or inductor-capacitor-resistor filter, the capacitor(s) being effectively electrically connected to the telephone line via saturation of the ferromagnetic core 38 of the series connected transformer 20, or at least one of the transformers, if a plurality of saturable transformers is employed. The saturation and unsaturation occur as a consequence of a supervisory signal consisting of an electrical direct current of sufficient magnitude through the windings or coils 30, 32 of transformer 20. In one embodiment of this invention, the transformer 20 is a coupled inductor transformer.

In the present invention, the saturable transformer 20 has many turns of wire to provide the large inductance and impedance required. Moreover, the diameter of the coil wire is chosen to be as large as possible so that DC electrical resistance of the windings or coils 30 and 32 are as small as possible. In the detailed embodiment of the invention illustrated in FIG. 1 and discussed above, the low-pass filter circuit 10 is a 4^{th} order Chebyshev filter. While the invention has been described in reference to a specific embodiment, the description is illustrative of the invention and is not to be construed as limiting the invention. Various modifications and applications may occur to those skilled in the art without departing from the true spirit and scope of the invention as defined by the appended claims. For example, a 3^{rd} order Butterworth low-pass filter, or 5^{th} order Bessel low-pass filter are considered to be equivalent circuits which those skilled in the art would understand to fall within the scope of the invention.

The filter circuit 10 detailed above provides an approximation to a passive 4^{th} order Chebyshev low-pass filter having 0.1 dB passband ripple, with saturable core transformer 20 implementing an impedance-blocking function in response to an electrical direct current IDC flowing through the saturable transformer windings or wires 34, 36. This direct current magnetically saturates the core 38 of the saturable core transformer and effectively switches ON the low-pass filter. At less than 1 mADC in the preferred embodiment the transformer's magnetic core 38 will be saturated. The switching innovation is designed to reduce circuit loading on a plain-old-telephone system (POTS) line in DSL applications when more than one such circuit is connected in parallel with the others. The filter circuit 10 may have a response of −0.1 dB@4.1 kHz to −3.01 dB@5.0 kHz and a high frequency rolloff of −60 dB/decade. When the two coils are connected in the intended series-aiding configuration, L_{P}=24.4 mHy (OCL)@1.0 kHz, 100 mVRMS.

FIG. 2 depicts an alternative embodiment of the present invention of filter circuit 60 of the present invention. In the filter circuit 60, the input comes from a POTS line 14 to a saturable inductor 64. The output of the saturable inductor is connected to the input of a filtering inductor 66 as well as to one side of a filter capacitor 68. The output of the filtering inductor 66 is connected to a shunt capacitor 70 as well as in series to the POTS communication device 12 represented as a 600 ohms resistant load. The opposite terminal of the output of the POTS communication device 12 (represented as a 600 ohm resistant load) is connected first to the opposite side of shunt capacitor 70 and subsequently to the opposite side of filtering capacitor 68 and then output to the POTS line 14. In this single ended configuration, the saturable core transformer 20 of FIG. 1 is replaced with the saturable inductor 64 having an inductance of 22 milliHenries. The filtering inductor 66 has an inductance of 33.4 milliHenries. The filtering capacitor 68 has a capacitance of 100 nanofarads and the shunt capacitor 70 has a capacitance of 56 nanofarads. However, there may be some performance degradation in the use of this configuration as opposed to the balanced configuration of FIG. 1.

Notwithstanding that FIGS. 1 and 2 show coupled transformers or inductors whose windings aid one another rather than oppose one another in the establishment of the magnetic fields within their respective cores, the scope of this invention includes the incorporation of non-saturable transformers as the second filtering transformer whose windings create magnetic fields that oppose one another; that is, the scope of this invention includes “common-mode” transformers. Such transformers can be placed in cascade with any other transformer(s), provided that a saturable inductor or transformer is the transformer connected to the telephone line.

Although specific components with particular operating parameters are described in the preferred embodiment, a variety of different components with varying operating parameters may be used which do not depart from the scope of the present invention. The preferred embodiment described above are for exemplary purposes only. While the filter circuit can be configured as a separate electrical element, it should be appreciated that the circuit can readily be incorporated into the design of a telephone or other device connected to the POTS line. The invention applies to all types of combinations and/or rearrangements of the methods and systems described. It is to be understood that the invention is not limited to these specific embodiments. With respect to the claims, it is the applicant's intention that the claims not be interpreted in accordance with the sixth paragraph of 35 U.S.C. §112 unless the term “means” is used followed by a functional statement.

What is claimed is:

1. A passive electrical low-pass filter for use in Digital Subscriber Line (DSL) applications on Plain Old Telephone System (POTS) lines, comprising:
a switched impedance-filtering circuit having a low impedance when a saturable inductor is energized by current from said POTS line and a high impedance when no current is provided to said saturable inductor by said POTS line.

2. The passive electrical low-pass filter of claim 1, wherein said filtering circuit has at least one saturable inductor that has two magnetic states, saturated and unsaturated.

3. The passive electrical low-pass filter of claim 2, wherein said saturable inductor has a very high input impedance when unsaturated, and an input impedance equal to a preferred filter input impedance when saturated, thereby providing the two states of the switched impedance-blocking filtering circuit.

4. The passive electrical low-pass filter of claim 2, wherein said saturable inductor has a residual inductance in its saturated state that is equal to a preferred open-circuit inductance required for said low-pass filter to have a cutoff frequency and rate of gain roll-off with frequency adequate to filter a DSL signal in the range of between 4.1 kHz and 5 MHz.

5. The passive electrical low-pass filter of claim 2, wherein said saturable inductor has a residual inductance in its saturated state that is equal to a preferred open-circuit inductance required for said low-pass filter to have a cutoff frequency and rate of gain roll-off with frequency adequate to filter a DSL signal in the range of between 25 kHz and 1.1 MHz.

6. An electrical filter for a Plain Old Telephone System (POTS) device connected to a POTS line, comprising:
a saturable core transformer having at least two windings and a saturable core, said transformer adapted to be electrically coupled to DC power from the POTS line;
a filter transformer, said filter transformer electrically connected to said saturable core transformer, and a filtering capacitor coupled across said saturable core transformer.

7. The electrical filter according to claim 6 further comprising a shunt capacitor coupled across said filter transformer.

8. The electrical filter according to claim 6 wherein said filter has a cutoff frequency and rate of gain roll-off with frequency adequate to filter a signal in the range of between 25 kHz and 1.1 MHz.

9. The electrical filter according to claim 6 wherein said filter has a cutoff frequency and rate of gain roll-off with frequency adequate to filter a signal in the range of between 4.1 kHz and 5 MHz.

10. The electrical filter according to claim 6 wherein the saturable core further comprises a stack of thin laminations of high magnetic permeability ferromagnetic material.

11. The electrical filter according to claim 6 wherein said saturable core transformer comprises a pair of windings or coils wrapped around a core element formed of high magnetic permeability ferromagnetic material.

12. The electrical filter according to claim 6 wherein said filtering capacitor is a 0.1 microfarad, 100V capacitor.

13. The electrical filter according to claim 7 wherein said shunt capacitor is a 0.056 μfd, 50V capacitor.

14. The electrical filter according to claim 6 wherein said filter circuit is designed to filter a DSL signal between 4.1 kHz and 5.0 kHz and having a high frequency rolloff of −60 dB/decade.

15. The electrical filter according to claim 6 wherein said saturable core transformer and said filter transformer are connected as two cascade coupled transformers with said filter capacitor coupled across the cascade connection.

16. A passive DSL signal filter apparatus for a POTS line, comprising:
a saturable core inductor adapted to be coupled to a POTS line such that when said saturable core inductor is energized by a DC voltage from said POTS line said DSL signal filter is enabled and when said saturable core inductor is not energized by a DC voltage, said DSL signal filter is disabled, and
at least one capacitor coupled to said saturable core inductor.

17. The DSL signal filter according to claim 16 wherein said DSL signal filter is equivalent to a 4th order Chebyshev low-pass filter, a 3rd order Butterworth low-pass filter or a 5th order Bessel low-pass filter.

18. The DSL filter according to claim 16 further comprising:
a filtering inductor connected to the output of said saturable core inductor and one side of said at least one capacitor.

19. A method of filtering DSL signals on a Plain Old Telephone System (POTS) line having multiple POTS devices connected to the POTS line also providing the DSL signal, comprising:
providing a passive electrical filter for each POTS device, each of said passive electrical filters having a switched impedance-filtering circuit having a high impedance when a saturable inductor is energized by current from said POTS line and a low impedance when no current is provided to said saturable inductor by said POTS line.
connecting said passive electrical filter devices between a common POTS line and each POTS device;
enabling said passive electrical filter devices only when the associated POTS device is off-hook.

20. The method according to claim 20 further comprising:
installing the passive electrical filter within the POTS device.

21. The method according to claim 19 wherein the passive electrical filter is equivalent to a 4th order Chebyshev low-pass filter, a 3rd order Butterworth low-pass filter or a 5th order Bessel low-pass filter.
